(19) United States
(12) Patent Application Publication
(10) Pub. No.: US 2012/0259800 A1
(43) Pub. Date: Oct. 11, 2012

(54) Method for Investor Acquisition of Income Producing Property

(75) Inventors: N. Jean Evers, Valley Center, KS (US); Timothy J. Malone, Valley Center, KS (US)

(73) Assignee: Pinnacle Consulting, L.L.C., Valley Center, KS (US)

(21) Appl. No.: 13/082,607

(22) Filed: Apr. 8, 2011

(51) Int. Cl. G06Q 90/00

(52) U.S. Cl. 705/500

(57) ABSTRACT

A method for an investor's lender financed acquisition from a property owner of tangible income producing property, the method including steps of purchasing for a first purchase price the tangible income producing property from an initial property owner, the tangible income producing property producing a first income stream; purchasing for a second purchase price from a plurality of life insurance policy owners a plurality of life insurance policies, the plurality of life insurance policies producing a second income stream comprising death benefits; and borrowing under a loan from the lender funds for purposes selected from the group consisting of payment of a portion of the first purchase price, payment of a portion of the second purchase price, and payment of a portion of the cumulative first and second purchase prices, the loan having terms of payment which may be served by said income streams.

### FIELD OF THE INVENTION

This invention relates to property investment methods, processes, and practices. More particularly, this invention relates to such methods, processes, and practices which operate to diminish cash flow demands against the borrower and/or diminish the lender's risk of loss through default by varying the character of the properties acquired with loan proceeds.

### BACKGROUND OF THE INVENTION

In conventional modes of lender financed acquisitions of income producing properties, cash flow demands borne by the investor/borrower during the lender financed property acquisition phase typically consist of the costs of debt service during the terms of the purchase money loan, and the costs of maintaining, insuring, and managing the income producing properties which are targeted for acquisition. Such cash flow demands are typically relieved only by the income stream which is produced by the purchased property. Such conventional mode of lender financed investment property acquisition is typically undesirably inflexible, hindering the lender's and investor's abilities to vary and relieve the cash flow demands directed against the investor and to vary and relieve lender's exposure to loan default risks.

The instant inventive method for investment property acquisition solves or ameliorates the problems discussed above by “bundling” a symbiotically matched or tailored portfolio of life insurance policies with the income producing property which is targeted for acquisition. By including such portfolio of life insurance policies within the group of properties purchased with the loan proceeds, cash flow demands borne the property investor may be advantageously relieved during the term of the loan and/or the lender's risk of loss through default may be advantageously lessened while maintaining the lender's debt investment for the loan's term.

### BRIEF SUMMARY OF THE INVENTION

The instant inventive method has at its focus the desirable goal pursued by an investor of acquiring ownership and title to tangible income producing property. In suitable modes of performing the instant inventive method, such property targeted for acquisition may be an office building including rentable office space. Alternatively, the tangible income producing property may be hotel or apartment properties. Other types of tangible income producing properties such as ocean going vessels, aircraft, and fleets of over the road vehicles suitably fall into the scope of the invention.

Upon identifying an item or group of tangible income producing properties which are desirably obtained by the investor, an asset purchase contract is negotiated with the initial owners of the income producing properties. In accordance with the method of the instant invention, at least a portion, and preferably a major portion of the negotiated purchase price (i.e., a first purchase price) is funded with the proceeds of a loan from a lender who is knowledgeable of the inventive method and is in participating cooperation with the investor. Suitably, the title to the income producing property which is purchased from the initial property owner may be received directly by the investor, with the investor granting a mortgage, security interest, or trust deed to the lender.

However, in a preferred mode of performance of the method, which is further described in the Detailed Description below, a lender protection trust is established for the receipt of title to the target income producing property and for holding such title during the acquisition financing period. As fiduciary holder of the income producing property, the lender protection trust receives and manages the investment property's income, which comprises a first income stream.

In a further step of the instant inventive method, a group of owners of life insurance policies who are interested in selling their policies are identified. In situations where an owner of a life insurance policy is no longer in need of the future security offered by the death benefits payable under the policy, or where such owner is no longer able to pay the periodic premiums needed to maintain the policy, such policy owner may conventionally surrender the life insurance policy to the insuring company in exchange for payment of the policy's cash surrender value. Alternatively, and more advantageously, such life insurance policy owner may enter into a life settlement financial transaction under which a premium price over and above the policy's cash surrender value is paid for the owner's policy assignment.

An asset portfolio containing a plurality of such life insurance policies, each typically acquired through a life settlement transaction, is preferably acquired in much the same manner as the above described initial acquisition of the targeted income producing property. As with the targeted income producing property, the ownership of the portfolio of life insurance policies may be placed directly with the investor with a security interest therein granted by the investor to the lender or, more desirably, the lender protection trust may act as the holder of the portfolio of life insurance policies. Lender loan proceeds preferably pay as a second purchase price the acquisition cost of the portfolio of life insurance policies.

In a preferred mode of performance of the instant method, a company such as a life expectancy provider, or other company specializing in actuarial analysis, is engaged to analyze and give opinions of the life expectancies of the individual insureds listed among the portfolio of life insurance policies. Following actuarial analysis of the life expectancies of the insureds, a financial analysis is preferably performed to project the likely course of death benefit payments (i.e., a second income stream) which will be produced by the portfolio over time.

The terms of financing which are negotiated with the lender may advantageously take into account the expected course of death benefits payments so that such payments progressively decrease the principal balance of the loan over the life of the loan. Alternatively, the death benefits may be held in trust, resulting in progressive reductions of the lender's default risk exposure over the life of the loan. In a preferred mode of performance of the inventive method, the maturity date of the investment property and insurance portfolio acquisition loan is negotiated and is set to occur on or after a projected date at which the portfolio of life insurance policies will produce death benefits cumulatively equaling the loan's principal balance.

Upon reaching the maturity date of the property acquisition loan, death benefits produced by the portfolio of life insurance policies typically will have satisfied and retired the loan. At that point in the life of the loan, security commitments to the lender, such as mortgages, security interests, and deeds of trust granted to the lender may be released, leaving the investor with clear and unencumbered ownership of the targeted income producing property, along with any remaining and outstanding life insurance policies within the policy portfolio.

In the event that some portion of the loan's principal balance remains outstanding upon the loan's maturity, the inventive method desirably provides for sale and liquidation of a sufficient portion of the remaining portfolio of life insurance policies to retire the loan. Thereafter, clear title to the income producing property and any remaining portfolio of life insurance policies or their liquidation values become owned free and clear by the investor.

The instant inventive method does burden an otherwise traditional investment property purchase with the additional capital investment of the purchase price of the portfolio of life insurance policies, and the method entails a cash flow burden in the form of policy premium payments. Yet, these disadvantages are accommodated and counter-balanced by the actuarial certainty of the deaths of the insured and the policies' contractually established death benefits. Financial time value adjusted margins existing between typical life settlement proceeds received by life insurance policy owners and the defined death benefits under their policies allow actuarially analyzed portfolios including assignments of those policies to be advantageously bundled with the targeted investment property according to the methods described above, and the margins and bundling practice more than compensates for the noted disadvantages. Enhanced lender security, improved access to lender financing, and reduced cash flow demands upon the investor during the loan term tend to facilitate investor property acquisitions where more traditional financing modes would fail.

Accordingly, objects of the instant invention include the provision of a method for an investor's lender financed acquisition from a property owner of a tangible income producing property which includes and incorporates method steps, as described above, and which functionally interrelates those steps in the manners described above.

Other and further objects, benefits, and advantages of the instant inventive method will become known to those skilled in the art upon review of the Detailed Description which follows, and upon review of the appended drawings.

### BRIEF DESCRIPTION OF THE DRAWINGS

FIG. 1 is a flow chart diagram of the instant inventive method for an investor's lender financed acquisition from a property owner of a tangible income producing property.

FIG. 2 alternatively presents the method of FIG. 1, the figure omitting a step of establishment of a lender protection trust.

### DETAILED DESCRIPTION OF PREFERRED MODES OF PERFORMANCE OF THE METHOD OF THE INVENTION

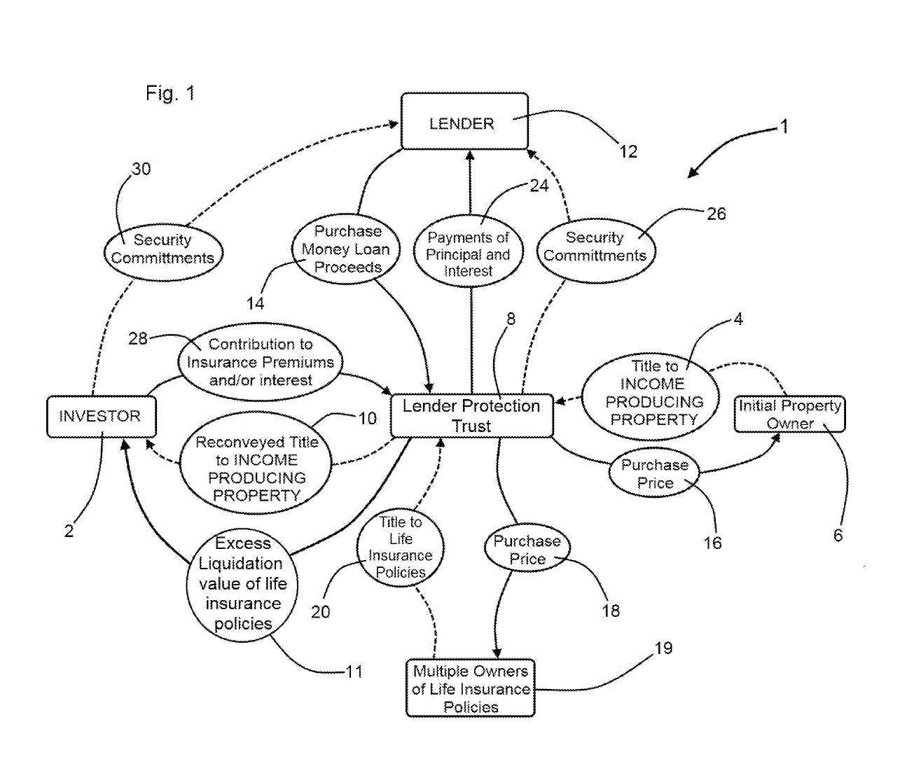

Referring now to the drawings, and in particular to FIG. 1, a flow chart diagram of a preferred mode of performance of the instant inventive method for an investor's lender financed acquisition from a property owner of tangible income producing property is referred to generally by Reference Arrow 1. According to the method 1, an investor 2 desirably identifies as an acquisition target an item or items of income producing property 4. The income producing property 4 may suitably comprise properties such as commercial office buildings, apartment buildings, aircraft, ocean going vessels, or other items of income producing property. Purchase negotiations necessarily proceed with the owner 6 of the income producing property 4, such negotiations preferably establishing a first contract purchase price 16 for the acquisition of the property 4.

A lender protection trust 8 is preferably established and the party negotiating the first purchase price 16 may suitably comprise either the investor 2 or the lender protection trust 8 acting by and through its trustee. Suitably, such trustee of the lender protection trust 8 and the investor 2 may constitute one and the same individual or business entity. Alternatively, the lender protection trust 8 may function under the auspices of a facilitating company which operates as trustee in manner of a title company escrow department or a bank trust department. In the preferred mode of performance of the method, title to the income producing property 4 is initially held as a part of the corpus of the trust 8, and income from such property flows into the trust 8 as a first income stream.

Referring further to FIG. 1, at least a part of the first purchase price 16 negotiated for the acquisition of the income producing property 4, and preferably a major portion of such purchase price is funded with a portion of purchase money loan proceeds 14 which are borrowed from a specialized lender 12 who is knowledgeable of the method and is in cooperation. Suitably, the purchase money loan proceeds 14 may pass through the lender protection trust 8 to fund payment of the first purchase price 16. Also suitably, the lender protection trust 8 may be positioned as the lender's principal borrower. Alternatively, the investor 2 may be established as the lender's principal borrower. Where the lender protection trust 8 is recognized as the principal borrower of the lender 12, security commitments 30 granted by the investor 2 unto the lender 12 preferably include the investor's personal guaranty.

Substantially simultaneously with the above referenced identification and targeting of the income producing property 4, a portfolio of life insurance policies formerly owned by multiple life insurance policy owners 19 is assembled and compiled. As with the first purchase 16 of the income producing property 4, a second portion of the purchase money loan proceeds 14 are preferably advanced to fund all or a major portion of a second purchase price 18 by which the life insurance policy portfolio 19 is acquired. The corpus of the lender protection trust 8 preferably additionally includes title 20 to and ownership of the portfolio of life insurance policies.

In a preferred mode of performance of the inventive method, the payment terms of the purchase money loan which generates loan proceeds 14 are negotiated, tailored, and fitted to be augmented and served by a forecasted course of payment of death benefits from the portfolio of life insurance policies 19,20. Such forecast is preferably derived from actuarial and financial analyses specifically directed to the portfolio of life insurance policies 19,20 so that the loan payment terms and benefits payment performance of the life insurance portfolio are closely coordinated. Preferably, the maturity date of the purchase money loan is established to postdate a projected time at which a sufficient level of death benefits from the life insurance policy portfolio is expected to have been realized.

Over the life of the purchase money loan, sporadically received death benefits may be deposited within and may magnify the corpus of the lender protection trust, such steps advantageously progressively lessening the lender's risk of loss through loan default. Such mode of accumulating the life insurance policy death benefits acts as a positive inducement to the lender to enter into the loan transaction, and may result in lowering of the interest rate charged to the investor 2. Alternatively, such death benefits which predate the term of the loan may be immediately remitted to the lender 12 in reduction of the loan's principal balance. In such mode of handling the death benefits, the investor 2 advantageously experiences a progressive lessening of its loan interest expenses over the life of the loan, advantageously lessening cash flow demands burdening the investor 2 and the lender protection trust 8.

A portion of the security commitments 26 extending from the lender protection trust 8 to the lender 12 preferably include trust beneficiary terms establishing that during the life of the loan the lender constitutes the sole and primary beneficiary under the trust. Additional security commitments 26 extended to the lender 12 may comprise a mortgage or security interest in the income producing property 4, a deed of trust to the income producing property 4, a security interest in the portfolio of life insurance policies 19,20 and, where the investor 2 is named as the lender's principal borrower, the loan payment guaranty of the lender protection trust 8.

Duties of the lender protection trust 8 preferably include compiling and establishing the portfolio of life insurance policies 19,20 and coordinating the forecasted death benefits from such portfolio with the negotiated terms of the purchase money loan 14. The lender protection trust 8 may also negotiate and contract for the acquisition of the income producing property 4 and may act as a conduit for payment of the purchase money loan proceeds 14 advanced therefor. Additionally, the lender protection trust 8 may have ongoing responsibilities for remitting scheduled loan payments 24 to the lender, keeping track of insureds under the portfolio 19,20, processing death benefits claims as the insureds die, maintaining the life insurance policy portfolio 19,20 through timely premium payments, and maintaining and managing the income producing property 4, along with its first income stream.

In an ideal mode performance of the instant inventive method, the contributions to insurance premiums and interest 28 which are made by the investor 2 are set at a level markedly less than that which would otherwise be experienced by the investor in conventional lender financed acquisition of the same investment property 4. The ability of the instant method to satisfy the lender 12 with “interest only” payments prior to loan maturity is a factor reducing the investor's cash flow burden.

Referring further to FIG. 1, upon maturation of the purchase money loan 14, life insurance death benefits accumulated within the lender protection trust 8 are typically sufficient to retire the loan by paying off its principal balance. Alternatively, where death benefits are progressively paid to the lender over the life of the loan, the principal balance of the loan will typically have been reduced to zero at or near the loan's maturity date. In the event that total death benefits realized as of loan maturity are insufficient to retire the purchase money loan, the instant method preferably provides that a portion of the remaining portfolio of life insurance policies 19,20 be liquidated in order to retire the purchase money loan 14 without resort to other resources. Suitably, the investor may utilize other resources to pay such insufficiency. According to the method, the liquidation value remaining within the life insurance policy portfolio as of loan maturity is assured to equal or exceed any loan balance which is not covered by realized death benefits. The portfolio devaluating effect of any unforecasted longevity of the insureds named in the portfolio necessarily diminishes over the life of the loan, such diminishment advantageously guaranteeing that a portfolio value sufficient to pay off the loan at maturity will exist.

Referring to FIG. 1, at the termination of performance of the inventive method, releases and satisfactions of the security commitments 26 are granted by the lender, and the lender protection trust 8 then conveys the initial income producing property 4 as reconveyed title 10 to the investor 2.

Any excess liquidation value 11 of the portfolio of life insurance policies 19,20 is preferably additionally paid to the investor 2 at the termination of performance of the method, the lender protection trust 8 having a final duty and responsibility of executing such portfolio liquidation. Alternatively, the trust may convey the portfolio in kind to the investor, or the trust may remain in existence to serve as an ongoing portfolio manager.

At the termination of performance of steps of the instant inventive method, the lender protection trust is typically divested of all property, and all debts owed to the lender 12 are satisfied. Accordingly at that point, the lender protection trust 8 may typically be terminated.

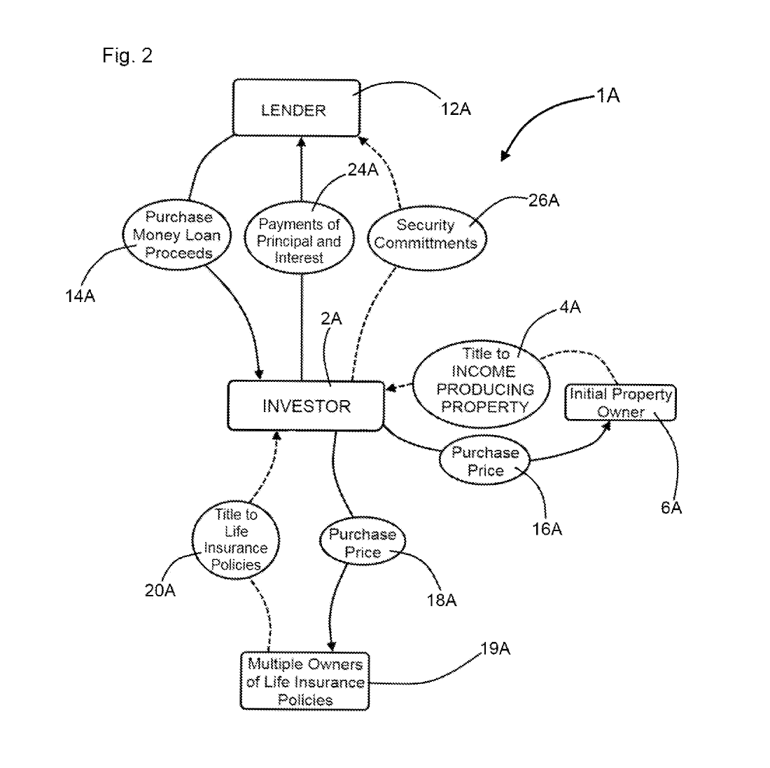

Referring to FIG. 2, a flow chart diagram of a suitable, though less desirable mode of performance of the instant inventive method is referred to generally by Reference Arrow A. In FIG. 2 each reference numeral having the suffix “A” denotes a method step performed substantially identically with similarly numbered method steps represented in FIG. 1. In the method of FIG. 2, all of the activities of the lender protection trust of FIG. 1 are performed by the investor 2A, and the fiduciary duties owed by the lender protection trust 8 to the lender 12 of FIG. 1 are replaced and are imposed as a matter of contract as direct duties of the investor 2A owed to the lender 12A. While all of the advantages of tailoring of the portfolio of life insurance policies 19A,20A to the terms of the purchase money loan 14A are present within the alternative mode of performance of FIG. 2, such mode is less desirable than the mode of FIG. 1 because the mode of FIG. 2 provides a less favorable repository for life insurance death benefits which are realized during the term of the loan. By establishing a lender protection trust 8, the lender 12 is not required to experience partial loan prepayments upon each receipt of a death benefit during the life of the loan since such benefits may be held in trust for the benefit of the lender. Accordingly, by utilizing the lender protection trust 8, the lender 12 may advantageously opt to realize its contracted for loan interest rate over the life of the loan while the lender's risk of loss through default progressively diminishes as paid death benefits periodically expand the liquid holdings of the lender protection trust 8.

While the principles of the invention have been made clear in the above illustrative embodiment, those skilled in the art may make modifications in the method steps of the invention and their modes and sequences of performance without departing from those principles. Accordingly, it is intended that the description and drawings be interpreted as illustrative and not in the limiting sense, and that the invention be given a scope commensurate with the appended claims.

I claim:

1. A method for an investor's lender financed acquisition from a property owner of tangible income producing property, the method comprising steps of:
(a) purchasing for a first purchase price the tangible income producing property from the property owner, the tangible income producing property producing a first income stream;
(b) purchasing for a second purchase price from a plurality of life insurance policy owners a plurality of life insurance policies, the plurality of life insurance policies producing a second income stream comprising death benefits; and
(c) borrowing under a loan from the lender funds for purposes selected from the group consisting of payment of a portion of the first purchase price, payment of a portion of the second purchase price, and payment of a portion of the cumulative first and second purchase prices, the loan having terms of payment which may be served by the second income stream.

2. The method of claim 1 further comprising a step of granting collateral security to the lender, the collateral security comprising properties selected from the group consisting of the tangible income producing property and the plurality of life insurance policies.

3. The method of claim 2 further comprising steps of actuarially matching the plurality of life insurance policies with the term of the loan so that the loan's maturity occurs on or after a date that forecasted cumulative death benefits produced by the portfolio of life insurance policies exceed the loan's principal balance.

4. The method of claim 2 further comprising a step of establishing a lender protection trust, the corpus of the lender protection trust comprising the tangible income producing property and the plurality of life insurance policies.

5. The method of claim 4 wherein, while the loan remains in force, the lender protection trust's primary beneficiary comprises the lender.

6. The method of claim 5 wherein trustee's duties under the lender protection trust comprise responsibilities selected from the group consisting of negotiating the first purchase price, executing the purchase of the tangible income producing property, purchasing and compiling as an asset portfolio the plurality of life insurance policies, maintaining and managing the tangible income producing property, paying life insurance premiums, tracking life insurance policy insureds, making life insurance death benefits claims, and paying loan payments to the lender.

7. The method of claim 6 further comprising a step of conveying the tangible income producing property to the investor, said tangible income producing property conveying step being performed by the lender protection trust following retirement of the loan.

8. The method of claim 7 further comprising steps of conveying residual life insurance policies among the portfolio of life insurance policies or the liquidation values of such residual policies to the investor after retirement of the loan.
